(19) United States
(12) Patent Application Publication
(10) Pub. No.: US 2026/0105762 A1
(43) Pub. Date: Apr. 16, 2026

(54) VISUAL TARGET DETERMINATION METHOD AND VISUAL TARGET DETERMINATION SYSTEM

(71) Applicant: Panasonic Automotive Systems Co., Ltd., Kanagawa (JP)

(72) Inventors: Yosuke MATSUSHITA, Osaka (JP); Taiki IKEMIYA, Osaka (JP); Mitsuteru KATAOKA, Osaka (JP); Keisuke NAGATA, Osaka (JP); Soichi KIMURA, Osaka (JP)

(73) Assignee: Panasonic Automotive Systems Co., Ltd., Kanagawa (JP)

(21) Appl. No.: 19/329,769

(22) Filed: Sep. 16, 2025

(30) Foreign Application Priority Data
Oct. 10, 2024 (JP) 2024-178451

(51) Int. Cl. G06V 20/59; G06F 3/01; G06T 3/40; G06V 20/54; G06V 20/56

(52) U.S. Cl. CPC G06V 20/597; G06F 3/013; G06T 3/40; G06V 20/54; G06V 20/56; G06V 2201/07

(57) ABSTRACT

The visual target determination method includes: detecting a line of sight of a driver; detecting a gaze area based on the detected line of sight of the driver; acquiring an image obtained by capturing an area surrounding the vehicle; detecting a visual target candidate by recognizing an object included in the image; determining a traffic scene; determining whether the visual target candidate corresponding to the determined traffic scene is included in the gaze area; determining that the driver has performed appropriate visual recognition behavior in the determined traffic scene when the visual target candidate corresponding to the determined traffic scene is included in the gaze area; and determining that the driver has not performed the appropriate visual recognition behavior in the determined traffic scene when the visual target candidate corresponding to the determined traffic scene is not included in the gaze area.

### CROSS REFERENCE TO RELATED APPLICATION

The present application is based on and claims priority of Japanese Patent Application No. 2024-178451 filed on Oct. 10, 2024.

### FIELD

The present disclosure relates to visual target determination methods and visual target determination systems for determining visual targets of vehicle drivers.

### BACKGROUND

Patent Literature (PTL) 1 discloses a technology involving generating a saliency map based on a recognition result of objects surrounding a vehicle and a prediction result of vehicle behavior using vehicle information, and determining a visual target of a vehicle driver based on the saliency map and a gaze area of the driver.

### CITATION LIST

### Patent Literature

PTL 1: Japanese Patent No. 7263734

### SUMMARY

However, the system disclosed in PTL 1 can be improved upon.

In view of the above, the present disclosure provides a visual target determination method and the like capable of improving upon the above related art.

A visual target determination method according to the present disclosure includes: a line of sight detection process for detecting a line of sight of a driver driving a vehicle; a gaze area detection process for detecting a gaze area based on the line of sight, detected, of the driver, the gaze area being an area gazed at by the driver; an image acquisition process for acquiring an image obtained by capturing an area surrounding the vehicle; a visual target candidate detection process for detecting a visual target candidate by recognizing an object included in the image, the visual target candidate being a candidate for a target toward which the line of sight of the driver is directed; a scene determination process for determining a traffic scene that is a situation during driving of the vehicle; and a visual recognition behavior determination process for determining whether a visual target candidate corresponding to the traffic scene determined is included in the gaze area, and determining that the driver has performed appropriate visual recognition behavior in the traffic scene determined when the visual target candidate corresponding to the traffic scene determined is included in the gaze area, and determining that the driver has not performed the appropriate visual recognition behavior in the traffic scene determined when the visual target candidate corresponding to the traffic scene determined is not included in the gaze area.

A visual target determination system according to the present disclosure includes: a line of sight detector that detects a line of sight of a driver driving a vehicle; a gaze area detector that detects a gaze area based on the line of sight, detected, of the driver, the gaze area being an area gazed at by the driver; an image acquirer that acquires an image obtained by capturing an area surrounding the vehicle; a visual target candidate detector that detects a visual target candidate by recognizing an object included in the image, the visual target candidate being a candidate for a target toward which the line of sight of the driver is directed; a scene determiner that determines a traffic scene of the vehicle; and a visual recognition behavior determiner that determines whether a visual target candidate corresponding to the traffic scene determined is included in the gaze area, and determines that the driver has performed appropriate visual recognition behavior in the traffic scene determined when the visual target candidate corresponding to the traffic scene determined is included in the gaze area, and determines that the driver has not performed the appropriate visual recognition behavior in the traffic scene determined when the visual target candidate corresponding to the traffic scene determined is not included in the gaze area.

These comprehensive or specific aspects may be achieved in accordance with a system, a method, an integrated circuit, a computer program, or a computer readable recording medium, such as a compact disc-read only memory (CD-ROM), or may be achieved in accordance with an arbitrary combination of a system, a method, an integrated circuit, a computer program, and a recording medium.

The visual target determination method and the like according to an aspect of the present disclosure is capable of improving upon the above related art.

### BRIEF DESCRIPTION OF DRAWINGS

FIG. 1 is a diagram illustrating an example of input sources and output destinations for information handled by a visual target determination system according to an embodiment.

FIG. 2 is a block diagram illustrating an example of the visual target determination system according to the embodiment.

FIG. 3 is a flowchart illustrating an example of a visual target determination method according to the embodiment.

FIG. 4 is a diagram for explaining a gaze area detection method.

FIG. 5 is a diagram for explaining a visual target candidate detection method.

FIG. 6 is a diagram for explaining weights assigned to a gaze area and a visual target candidate area.

FIG. 7A is a diagram for explaining visual target determination tables.

FIG. 7B is a diagram for explaining the visual target determination tables.

### DESCRIPTION OF EMBODIMENT

Although there is a demand to determine whether the driver has viewed what should be viewed during driving, the technology disclosed in PTL 1 has no indication of such determination. Hereinafter, explanation is provided on a visual target determination method and a visual target determination system that determines whether the vehicle driver has viewed what should be viewed during driving.

Embodiments will be described in detail below with reference to the drawings.

The embodiments to be described below are comprehensive or specific examples. Numerical values, shapes, materials, components, positions and connection methods of the components, steps, the order of the steps, and so on indicated in the embodiments below are examples, and are not intended to limit the present disclosure.

### Embodiment

A visual target determination method and a visual target determination system according to an embodiment will be described below.

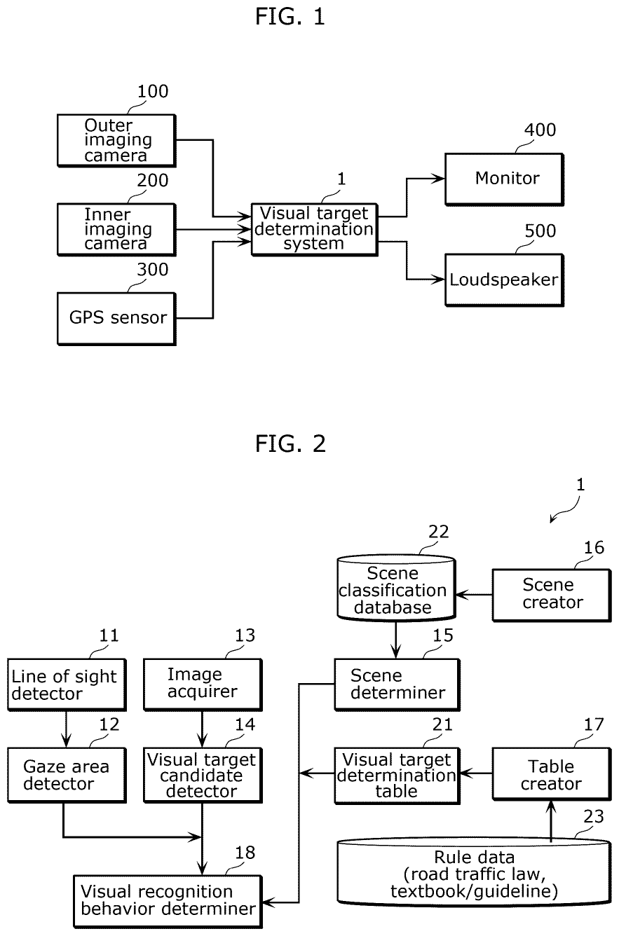

FIG. 1 is a diagram illustrating an example of input sources and output destinations for information handled by visual target determination system 1 according to the embodiment.

Visual target determination system 1 is a system applied to a vehicle. Visual target determination system 1 acquires information from outer imaging camera 100, inner imaging camera 200, global positioning system (GPS) sensor 300, and the like that are provided in the vehicle and outputs a result of determination performed by visual target determination system 1 to monitor 400 and loudspeaker 500. Outer imaging camera 100 is a camera that captures an image of an area surrounding the vehicle and is, for example, a camera provided in a drive recorder. Inner imaging camera 200 is a camera that captures an image of the vehicle interior and is, for example, a camera provided in a driver monitor. GPS sensor 300 is a sensor that detects the location of the vehicle. Monitor 400 may be a display (e.g., a car navigation display) provided in the vehicle or a display of a smartphone, a personal computer (PC), or the like. The PC may be provided outside the vehicle. Loudspeaker 500 may be a loudspeaker provided in the vehicle or a loudspeaker provided outside the vehicle. Visual target determination system 1 may be equipped with outer imaging camera 100, inner imaging camera 200, GPS sensor 300, monitor 400, or loudspeaker 500.

FIG. 2 is a block diagram illustrating an example of visual target determination system 1 according to the embodiment.

Visual target determination system 1 is a system that determines a visual target of a vehicle driver, and is specifically a system that determines whether the vehicle driver has viewed what should be viewed during driving.

Visual target determination system 1 includes line of sight detector 11, gaze area detector 12, image acquirer 13, visual target candidate detector 14, scene determiner 15, scene creator 16, table creator 17, and visual recognition behavior determiner 18. Visual target determination system 1 has stored therein visual target determination table 21, scene classification database 22, and rule data 23. Visual target determination system 1 is a computer that includes a processor (microprocessor), a memory, and the like. The memory includes a read only memory (ROM), a random access memory (RAM), and the like and can store a program to be executed by the processor. Line of sight detector 11, gaze area detector 12, image acquirer 13, visual target candidate detector 14, scene determiner 15, scene creator 16, table creator 17, and visual recognition behavior determiner 18 are implemented by the processor and the like executing the program stored in the memory.

For example, visual target determination system 1 may be a computer (device) in a single housing or may be a system constituted of multiple computers. For example, visual target determination system 1 may be a computer disposed in the vehicle or may be implemented as a function of the drive recorder or the driver monitor. Furthermore, for example, visual target determination system 1 may be a server. The components included in visual target determination system 1 and the data (such as visual target determination table 21, scene classification database 22, rule data 23 and the like) stored therein may be disposed in a single server, may be disposed distributively in multiple servers, or may be disposed distributively in the vehicle and the server.

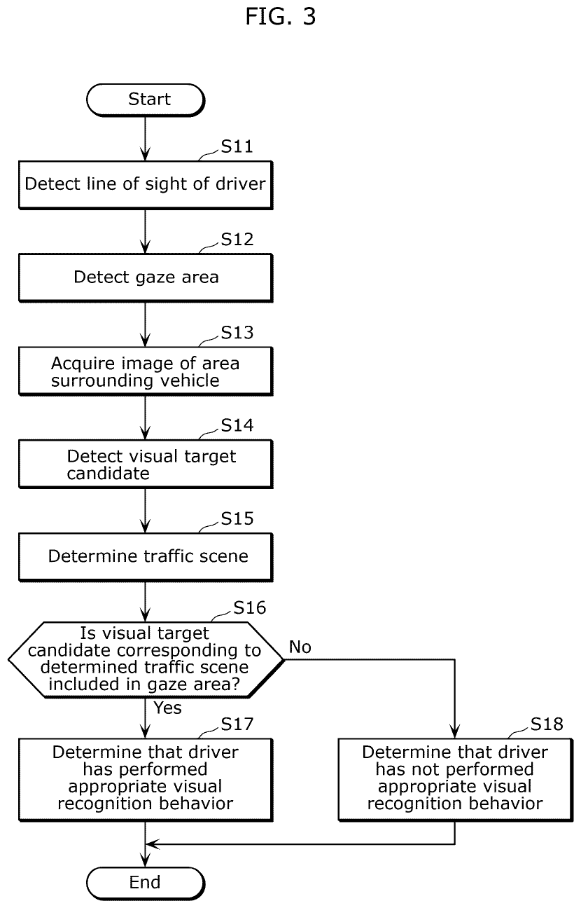

The details of the components included in visual target determination system 1 will now be described with reference to FIG. 3.

FIG. 3 is a flowchart illustrating an example of the visual target determination method according to the embodiment. Because the visual target determination method is a method executed by visual target determination system 1, FIG. 3 is also a flowchart illustrating an example of the operation of visual target determination system 1. A line of sight detection process is executed by line of sight detector 11, a gaze area detection process is executed by gaze area detector 12, an image acquisition process is executed by image acquirer 13, a visual target candidate detection process is executed by visual target candidate detector 14, a scene determination process is executed by scene determiner 15, and a visual recognition behavior determination process is executed by visual recognition behavior determiner 18.

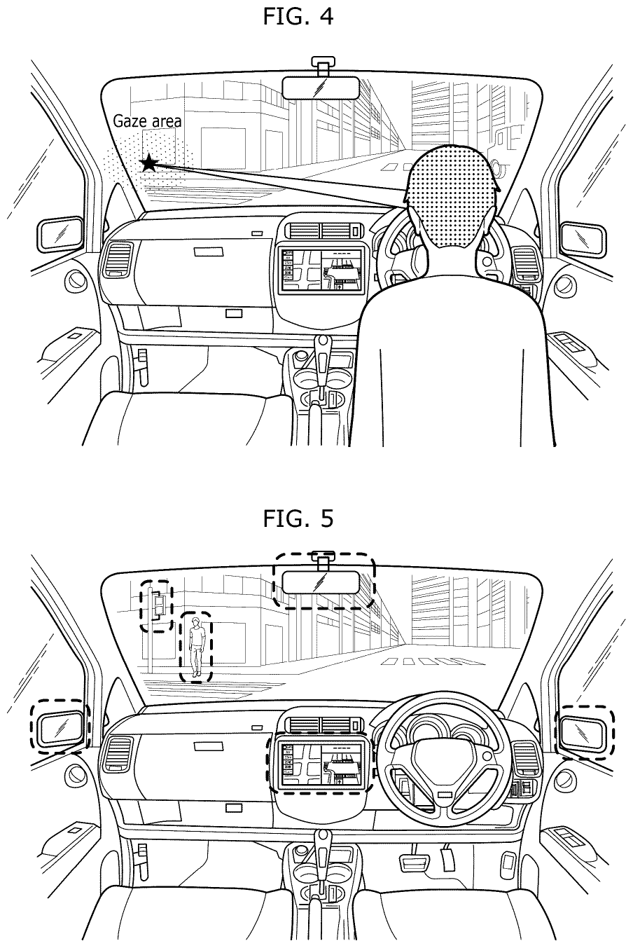

The line of sight detection process involves line of sight detector 11 detecting a line of sight of the vehicle driver (step S11), and the gaze area detection process involves gaze area detector 12 detecting a gaze area, which is an area gazed at by the driver, based on the detected line of sight of the driver (step S12). A gaze area detection method will be described here with reference to FIG. 4.

FIG. 4 is a diagram for explaining the gaze area detection method. In FIG. 4, the vehicle interior and the driver are illustrated.

For example, line of sight detector 11 detects the driver's face and eyes from an image of the driver obtained by inner imaging camera 200, and detects the driver's line of sight (i.e., the direction of the line of sight) from the orientation of the detected face and the movement of the detected eyes. For example, as illustrated in FIG. 4, the direction of the driver's line of sight, and, by extension, a gaze point (star symbol in FIG. 4), can be detected from the face orientation and the eye movement of the driver. Then, gaze area detector 12 detects, as a gaze area, an area with a predetermined size centered on the detected gaze point of the driver. The predetermined size is not particularly limited, and may be set from, for example, a range visually recognizable from the gaze point of a normal person.

In the gaze area detection process, gaze area detector 12 may adjust the size of the gaze area based on the driver's attributes, the vehicle state, or the environment surrounding the vehicle. For example, since a driver who is an elderly or who has low driving skills may possibly have a narrow visual field, the size of the gaze area may be reduced to match the visual field according to the driver's attributes. Furthermore, for example, since the driver's effective visual field may possibly become narrower when the vehicle is traveling at a high speed, the size of the gaze area may be reduced to match the driver's effective visual field according to the vehicle state. Moreover, for example, since the driver's visual field may possibly become narrower when the vehicle is traveling in bad weather or during nighttime, the size of the gaze area may be reduced to match the driver's visual field according to the environment surrounding the vehicle.

Referring back to FIG. 3, the image acquisition process involves image acquirer 13 acquiring an image obtained by capturing an area surrounding the vehicle (step S13), and the visual target candidate detection process involves visual target candidate detector 14 detecting a visual target candidate, which is a candidate for a target toward which the line of sight of the driver is directed, by recognizing an object included in the image (step S14). A visual target candidate detection method will be described here with reference to FIG. 5.

FIG. 5 is a diagram for explaining the visual target candidate detection method. In FIG. 5, the vehicle interior and objects existing outside the vehicle are illustrated.

For example, image acquirer 13 acquires an image, obtained by outer imaging camera 100, of an area surrounding the vehicle, and visual target candidate detector 14 uses object recognition artificial intelligence (AI) to recognize an object appearing in the image and detects a visual target candidate toward which the line of sight of the driver is directed during driving. For example, as illustrated in FIG. 5, visual target candidate detector 14 detects a traffic signal and a pedestrian as visual target candidates. Although not illustrated, other examples of visual target candidates include an animal, such as a dog, a cat or the like, an automobile, a bicycle, and the like.

In the visual target candidate detection process, visual target candidate detector 14 may further detect, as a visual target candidate, a preset object disposed in the vehicle. For example, as illustrated in FIG. 5, objects disposed in the vehicle, such as a rearview mirror, a left mirror, a right mirror, a car navigation system and the like, are set at relative angles with respect to an assumed position of the driver, so that these objects can be detected as visual target candidates. Although not illustrated, a left window, a right window, and the like may also be detected as visual target candidates. Since targets that should be viewed by the driver vary depending on the type of vehicle, visual target candidates to be detected also vary depending on the type of vehicle. For example, since a box-shaped truck may sometimes include a rearview monitor disposed therein in place of a rearview mirror, the rearview monitor may possibly become a visual target candidate. Moreover, for example, since a large truck may sometimes include more mirrors than a normal vehicle or include floor-level windows disposed therein, these may also possibly become visual target candidates.

Referring back to FIG. 3, the scene determination process involves scene determiner 15 determining a traffic scene, which is a situation during driving of the vehicle (step S15). For example, a traffic scene refers to a situation during driving of the vehicle, including where the vehicle is located and how the vehicle is controlled. Examples of traffic scenes include a situation where the vehicle is within an intersection when making a left turn, a situation where the vehicle is located in front of an intersection when making a left turn, and so on. In that case, the traffic scenes may be classified into a case where the vehicle makes a left turn after stopping at a red light and a case where the vehicle approaches an intersection at a blue light and directly makes a left turn. Another example of a traffic scene is a situation where the vehicle passes another vehicle on the highway. The traffic scenes may further be classified in detail based on the number of lanes or the like. There may also be traffic scenes that correspond to specific locations, such as a situation where the vehicle is in an accident-prone area, a situation where the vehicle is at an intersection with poor visibility due to an obstacle, such as a tree, and so on. Even when the vehicle is traveling on the same type of road, the traffic scene may differ between a situation where the vehicle is traveling on the road with heavy traffic and a situation where the vehicle is traveling on the road with light traffic.

These many traffic scenes are included in scene classification database 22. Since there may be a desire to add a traffic scene, for example, a manager of visual target determination system 1, an operation manager, a user of the vehicle, or the like may input the traffic scene to be added, so that scene creator 16 may create a new traffic scene and add the new traffic scene to scene classification database 22.

For example, in the scene determination process, scene determiner 15 may determine the traffic scene of the vehicle based on GPS data, the image obtained by capturing the area surrounding the vehicle, or map information. For example, when the vehicle's traveling direction indicated in the GPS data changes by 90 degrees, it can be determined that the vehicle is in a situation of making a right or left turn, and when the vehicle's traveling direction changes by 180 degrees, it can be determined that the vehicle is in a situation of moving rearward. These situations can also be determined from a change in scenery appearing in the image of the area surrounding the vehicle. When the map information includes information about road signs, traffic signals, stop points, or the like, it can be determined what type of road the vehicle is traveling on by using the map information.

Furthermore, for example, in the scene determination process, scene determiner 15 may determine the traffic scene of the vehicle based on vehicle information obtained from an electronic control unit (ECU) or the like of the vehicle. For example, it can be determined that the vehicle is in a situation of making a right or left turn based on information about the steering angle of the vehicle, and a situation regarding the speed at which the vehicle is traveling can be determined based on information about the engine rotation speed of the vehicle.

In the visual recognition behavior determination process, visual recognition behavior determiner 18 determines whether a visual target candidate corresponding to the determined traffic scene is included in the gaze area (step S16). When the visual target candidate corresponding to the determined traffic scene is included in the gaze area (Yes in step S16), it is determined that the driver has performed appropriate visual recognition behavior in the determined traffic scene (step S17). When the visual target candidate corresponding to the determined traffic scene is not included in the gaze area (No in step S16), it is determined that the driver has not performed appropriate visual recognition behavior in the determined traffic scene (step S18). A visual target that should be viewed by the driver is preset for every traffic scene. For example, when a visual target that should be viewed by the driver is a traffic signal in a traffic scene where the vehicle is located within an intersection when making a left turn, visual recognition behavior determiner 18 determines whether the traffic signal is included in the gaze area if the determined traffic scene is a traffic scene where the vehicle is located within an intersection when making a left turn. For example, when the traffic signal is not included in the gaze area, it can be determined that the driver has not performed appropriate visual recognition behavior.

For example, visual recognition behavior determiner 18 outputs a determination result indicating whether the driver has performed appropriate visual recognition behavior in the determined traffic scene (determination result output process). For example, visual recognition behavior determiner 18 may cause monitor 400 to display an image indicating the determination result or may cause loudspeaker 500 to output audio indicating the determination result. As mentioned above, monitor 400 and loudspeaker 500 may be provided in the vehicle or may be provided outside the vehicle. In other words, the vehicle driver may be notified of the determination result, or the operation manager or the like may be notified of the determination result.

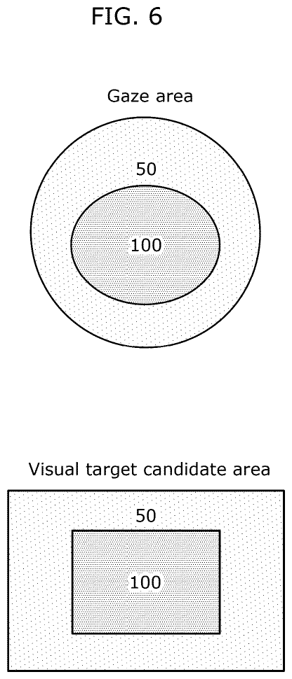

The determination may be performed while weights are assigned to the gaze area and each visual target candidate area. This will be described with reference to FIG. 6.

FIG. 6 is a diagram for explaining the weights assigned to the gaze area and the visual target candidate area.

For example, in the gaze area detection process, gaze area detector 12 may assign, to the gaze area, a weight that increases in value toward the center of the gaze area. In the visual target candidate detection process, visual target candidate detector 14 may assign, to the visual target candidate area, which is an area of the detected visual target candidate, a weight that increases in value toward the center of the visual target candidate area. For example, as illustrated in FIG. 6, a weight of 100 is assigned to an area close to the center of each of the gaze area and the visual target candidate area, and a weight of 50 is assigned to an area far from the center of each of the gaze area and the visual target candidate area. Then, in the visual recognition behavior determination process, visual recognition behavior determiner 18 may determine whether the visual target candidate constituting the visual target candidate area is included in the gaze area based on a sum of the value of the gaze area and the value of the visual target candidate area in an area where the gaze area and the visual target candidate area overlap.

Since an area located externally away from the center of the gaze area, which is the driver's gaze point, is an area that is difficult for the driver to visually recognize even when the area is within the gaze area, there is a possibility that an object within the relevant area is not properly visually recognized by the driver. Furthermore, when the driver views an area located externally away from the center of the visual target candidate area, there is a possibility that the visual target candidate is not properly visually recognized by the driver. By assigning weights to the gaze area and the visual target candidate area and calculating the sum of the values in the area where the gaze area and the visual target candidate area overlap, it can be comprehensively determined whether the driver has viewed the visual target candidate that should be visually recognized.

Furthermore, for example, in the visual target candidate detection process, when the detected visual target candidate is a predetermined object, visual target candidate detector 14 may expand the visual target candidate area, which is the area of the detected visual target candidate. For example, although a traffic signal is a small object when viewed from the driver, the driver can visually recognize the traffic signal without gazing at the traffic signal so long as the traffic signal is within the visual field to some extent. This is because traffic-related man-made objects are made so that they are readily visually recognizable by drivers. When such a small object is detected at its original size, it is determined that such an object is not included in the gaze area, possibly determining that the driver has not visually recognized the object even though the driver actually has. With regard to such a preset object, the visual target candidate area is expanded, thereby suppressing a situation where it is determined that the driver has not visually recognized the object even though the driver actually has.

Furthermore, for example, in the visual recognition behavior determination process, when the visual target candidate corresponding to the determined traffic scene is included in the gaze area for a predetermined time period or longer, visual recognition behavior determiner 18 may determine that the visual target candidate is included in the gaze area. In other words, when the visual target candidate corresponding to the determined traffic scene is not included in the gaze area for the predetermined time period or longer, visual recognition behavior determiner 18 may determine that the visual target candidate is not included in the gaze area. Accordingly, this can suppress a situation where it is determined that the driver has been viewing the visual target candidate, which should be visually recognized by the driver, by only momentarily viewing the visual target candidate.

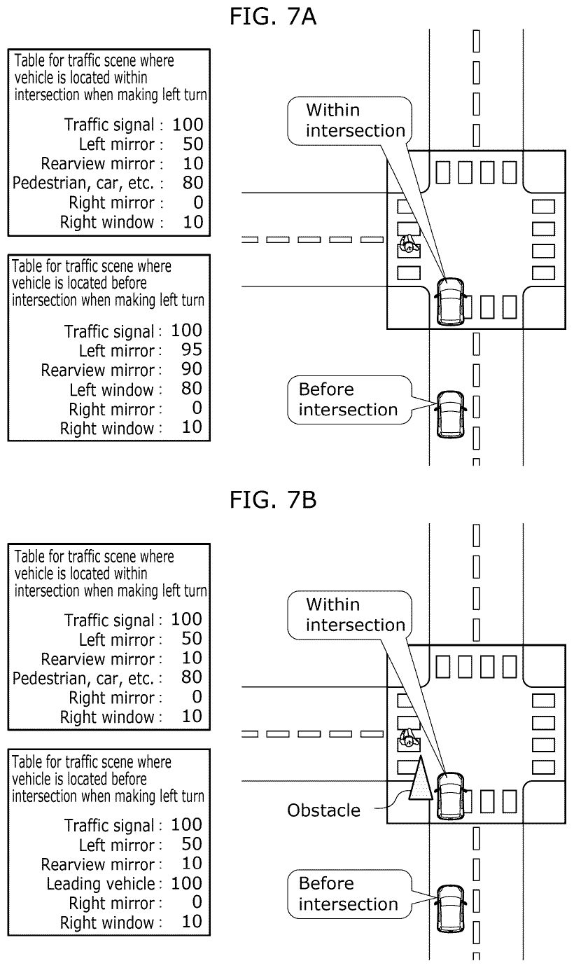

For example, in the visual recognition behavior determination process, visual recognition behavior determiner 18 may determine whether a visual target candidate included in visual target determination table 21 corresponding to the determined traffic scene, among multiple visual target determination tables 21 created for respective traffic scenes, is included in the gaze area. By preliminarily creating visual target determination tables 21, which include visual target candidates that should be visually recognized by the driver, for the respective traffic scenes, it can readily be determined whether the visual target candidate corresponding to the determined traffic scene is included in the gaze area. A specific example of visual target determination tables 21 will be described here with reference to FIG. 7A and FIG. 7B.

FIG. 7A and FIG. 7B are diagrams for explaining visual target determination tables 21. FIG. 7A and FIG. 7B each illustrate visual target determination table 21 corresponding to a traffic scene where the vehicle is located within an intersection when making a left turn and visual target determination table 21 corresponding to a traffic scene where the vehicle is located in front of the intersection when making a left turn. For example, each visual target determination table 21 includes visual targets that should be viewed by the driver in the relevant traffic scene and priority levels of the visual targets. FIG. 7B illustrates an example of visual target determination table 21 in a case where there is an obstacle at the intersection. The traffic scene may vary between the intersection with the obstacle and the intersection without the obstacle, and corresponding visual target determination table 21 may also vary. For example, as illustrated in FIG. 7A and FIG. 7B, visual target determination table 21 corresponding to the traffic scene where the vehicle is located in front of the intersection without an obstacle when making a left turn and visual target determination table 21 corresponding to the traffic scene where the vehicle is located in front of the intersection with an obstacle when making a left turn are different from each other.

For example, in the visual recognition behavior determination process, visual recognition behavior determiner 18 may determine whether a visual target candidate, which is included in visual target determination table 21 corresponding to the determined traffic scene and whose priority level is higher than or equal to a predetermined priority level, is included in the gaze area. For example, in the case where the predetermined priority level is 90, when the gaze area includes a traffic signal and a left mirror but does not include a rearview mirror in the traffic scene where the vehicle is located in front of the intersection when making a left turn, as illustrated in FIG. 7A, visual recognition behavior determiner 18 determines that the driver has not performed appropriate visual recognition behavior in the relevant traffic scene. Accordingly, a high priority visual target candidate included in visual target determination table 21 can be set as a visual target candidate that should be visually recognized by the driver. Furthermore, the visual target candidate that should be visually recognized by the driver can be adjusted by changing the predetermined priority level. For example, the number of visual target candidates that should be visually recognized by the driver can be increased by lowering the predetermined priority level, and the number of visual target candidates that should be visually recognized by the driver can be decreased by raising the predetermined priority level.

For example, in the visual recognition behavior determination process, visual recognition behavior determiner 18 may change the priority level of a visual target candidate included in visual target determination table 21 corresponding to the determined traffic scene in accordance with the distance between the vehicle and the visual target candidate. Accordingly, the priority level of the visual target candidate included in visual target determination table 21 can be optimized in accordance with the distance between the vehicle and the visual target candidate. For example, when there is a large distance between the vehicle and the visual target candidate, the necessity for the driver to visually recognize the visual target candidate is low. Thus, the visual target candidate can be lowered in priority level and can be removed from visual target candidates that should be visually recognized by the driver.

For example, in the visual recognition behavior determination process, when a visual target candidate included in visual target determination table 21 corresponding to a first traffic scene that has been determined is included in the gaze area, visual recognition behavior determiner 18 may lower the priority level of the relevant visual target candidate included in visual target determination table 21 corresponding to a second traffic scene that follows the determined first traffic scene. For example, in the successive first and second traffic scenes, a visual target candidate visually recognized by the driver in the first traffic scene sometimes does not have to be visually recognized again in the second traffic scene that follows the first traffic scene. With regard to the visual target candidate visually recognized by the driver in the first traffic scene, the priority level thereof may be lowered in the second traffic scene, so that the visual target candidate can be removed from visual target candidates that should be visually recognized by the driver in the second traffic scene.

For example, multiple visual target determination tables 21 may be created for respective traffic scenes based on the road traffic law, a traffic-related textbook, or the visual recognition behavior history of an arbitrary driver. For example, table creator 17 may create each visual target determination table 21 based on the road traffic law, the traffic-related textbook, and/or the like included in rule data 23. By using the road traffic law or the textbook, visual target candidates that should be visually recognized by the driver can be set for each traffic scene. With regard to a traffic scene where the vehicle travels on premises, an uncommon road, or the like where the road traffic law is not applied, visual target candidates that should be visually recognized by the driver can be set by referring to the visual recognition behavior history of a good driver or the like. Moreover, for example, the details of each visual target determination table 21 may be determined by the operation manager.

As described above, for every traffic scene, it can be determined whether a visual target candidate that should be visually recognized by the driver in the relevant traffic scene is included in the gaze area of the driver. In other words, for every traffic scene, it can be determined whether the driver has viewed the visual target candidate that should be visually recognized in the relevant traffic scene. Consequently, it can be determined whether the driver has viewed what should be viewed during driving.

### Other Embodiments

The embodiment has been described above as an example of a technique according to the present disclosure. However, the technique according to the present disclosure is not limited to this, and is applicable to an embodiment that has undergone a modification, a replacement, an addition, an omission, or the like, where appropriate. For example, the following variations are also included in one embodiment of the present disclosure.

For example, although the embodiment described above relates to an example where visual target determination system 1 includes scene creator 16, visual target determination system 1 does not have to include scene creator 16. Specifically, visual target determination system 1 does not necessarily have to include a function for adding a new traffic scene.

For example, although the embodiment described above relates to an example where visual target determination system 1 includes table creator 17 and rule data 23, visual target determination system 1 does not have to include table creator 17 and rule data 23. Specifically, visual target determination system 1 does not necessarily have to include a function for adding new visual target determination table 21.

For example, the present disclosure can be realized as a program for causing a computer (processor) to execute the processes included in the visual target determination method. Moreover, the present disclosure can be realized as a non-transitory computer readable recording medium, such as a CD-ROM, having the program recorded thereon.

For example, if the present disclosure is realized by the program (software), the program is executed by using hardware resources, such as a central processing unit (CPU), a memory, an input-output circuit, and the like, of the computer, so that the processes are executed. Specifically, the CPU performs a computation by acquiring data from the memory, the input-output circuit, or the like, and outputs the computational result to the memory, the input-output circuit, or the like, so that the processes are executed.

In the above embodiment, each of the components included in visual target determination system 1 may be constituted of dedicated hardware or may be realized by executing a software program suitable for the component. Each component may be realized by causing a program executer, such as the CPU, the processor, or the like, to read and execute a software program recorded on a recording medium, such as a hard disk, a semiconductor memory, or the like.

Typically, the functions of visual target determination system 1 according to the above embodiment are partially or entirely implemented as a large-scale integrated circuit (LSI), which is an integrated circuit. The functions may be individually integrated into a single chip, or may be integrated into a single chip to partially or entirely include the functions. The integrated circuit is not limited to LSI and may be a dedicated circuit or a general purpose circuit. A field programmable gate array (FPGA) programmable after LSI fabrication or a reconfigurable processor capable of reconfiguring the connections and configurations of circuit cells within the LSI may also be used.

If a new integrated circuit technology that replaces LSI due to an advanced semiconductor technology or a derivative technology emerges, the components included in visual target determination system 1 may naturally be configured as an integrated circuit by using such a technology.

The present disclosure also encompasses an embodiment obtained by applying various kinds of variations conceivable by a skilled person to the embodiment as well as an embodiment achieved by arbitrarily combining components and functions in each embodiment within a range not deviating from the scope of the present disclosure.

### Appendix

The following techniques are disclosed in accordance with the description of the above embodiment.

### Technique 1

A visual target determination method includes: a line of sight detection process for detecting a line of sight of a driver driving a vehicle; a gaze area detection process for detecting a gaze area based on the line of sight, detected, of the driver, the gaze area being an area gazed at by the driver; an image acquisition process for acquiring an image obtained by capturing an area surrounding the vehicle; a visual target candidate detection process for detecting a visual target candidate by recognizing an object included in the image, the visual target candidate being a candidate for a target toward which the line of sight of the driver is directed; a scene determination process for determining a traffic scene that is a situation during driving of the vehicle; and a visual recognition behavior determination process for determining whether a visual target candidate corresponding to the traffic scene determined is included in the gaze area, and determining that the driver has performed appropriate visual recognition behavior in the traffic scene determined when the visual target candidate corresponding to the traffic scene determined is included in the gaze area, and determining that the driver has not performed the appropriate visual recognition behavior in the traffic scene determined when the visual target candidate corresponding to the traffic scene determined is not included in the gaze area.

Accordingly, for every traffic scene, it can be determined whether a visual target candidate that should be visually recognized by the driver in the relevant traffic scene is included in the gaze area of the driver. In other words, for every traffic scene, it can be determined whether the driver has viewed the visual target candidate that should be visually recognized in the relevant traffic scene. Consequently, it can be determined whether the driver has viewed what should be viewed during driving.

### Technique 2

The visual target determination method according to technique 1, in which, in the visual recognition behavior determination process, whether a visual target candidate included in a visual target determination table corresponding to the traffic scene determined is included in the gaze area is determined, the visual target determination table being included in a plurality of visual target determination tables created for respective traffic scenes one of which is the traffic scene determined.

Accordingly, by preliminarily creating the visual target determination tables, which include visual target candidates that should be visually recognized by the driver, for the respective traffic scenes, it can readily be determined whether the visual target candidate corresponding to the determined traffic scene is included in the gaze area.

### Technique 3

The visual target determination method according to technique 2, in which, in the visual recognition behavior determination process, whether a visual target candidate having a priority level higher than or equal to a predetermined priority level is included in the gaze area is determined, the visual target candidate being included in the visual target determination table corresponding to the traffic scene determined.

Accordingly, a high priority visual target candidate included in the visual target determination table can be set as a visual target candidate that should be visually recognized by the driver. Furthermore, the visual target candidate that should be visually recognized by the driver can be adjusted by changing the predetermined priority level. For example, the number of visual target candidates that should be visually recognized by the driver can be increased by lowering the predetermined priority level, and the number of visual target candidates that should be visually recognized by the driver can be decreased by raising the predetermined priority level.

### Technique 4

The visual target determination method according to technique 3, in which, the visual recognition behavior determination process includes changing the priority level of the visual target candidate in accordance with a distance between the vehicle and the visual target candidate included in the visual target determination table corresponding to the traffic scene determined.

Accordingly, the priority level of the visual target candidate included in the visual target determination table can be optimized in accordance with the distance between the vehicle and the visual target candidate. For example, when there is a large distance between the vehicle and the visual target candidate, the necessity for the driver to visually recognize the visual target candidate is low. Thus, the visual target candidate can be lowered in priority level and can be removed from visual target candidates that should be visually recognized by the driver.

### Technique 5

The visual target determination method according to technique 3 or 4, in which, the visual recognition behavior determination process includes lowering a priority level of a visual target candidate included in a visual target determination table corresponding to a second traffic scene when a visual target candidate included in a visual target determination table corresponding to a first traffic scene that is determined is included in the gaze area, the first traffic scene and the second traffic scene being included in the respective traffic scenes, the second traffic scene following the first traffic scene.

For example, in the successive first and second traffic scenes, a visual target candidate visually recognized by the driver in the first traffic scene sometimes does not have to be visually recognized again in the second traffic scene that follows the first traffic scene. With regard to the visual target candidate visually recognized by the driver in the first traffic scene, the priority level thereof may be lowered in the second traffic scene, so that the visual target candidate can be removed from visual target candidates that should be visually recognized by the driver in the second traffic scene.

### Technique 6

The visual target determination method according to any one of techniques 2 to 5, in which, the plurality of visual target determination tables are created for the respective traffic scenes, based on a road traffic law, a traffic-related textbook, or a visual recognition behavior history of an arbitrary driver.

By using the road traffic law or the textbook, visual target candidates that should be visually recognized by the driver can be set for each traffic scene. With regard to a traffic scene where the vehicle travels on premises, an uncommon road, or the like where the road traffic law is not applied, visual target candidates that should be visually recognized by the driver can be set by referring to the visual recognition behavior history of a good driver or the like.

### Technique 7

The visual target determination method according to any one of techniques 1 to 6, in which, in the visual target candidate detection process, a preset object disposed in the vehicle is detected as the visual target candidate.

Accordingly, by presetting objects, such as a mirror, a window, and the like, disposed in the vehicle, such objects can be detected as visual target candidates.

### Technique 8

The visual target determination method according to any one of techniques 1 to 7, in which, in the scene determination process, the traffic scene of the vehicle is determined based on global positioning system (GPS) data, the image, or map information.

Accordingly, the traffic scene of the vehicle can be determined by using the GPS data, the image of the area surrounding the vehicle, or the map information. For example, when the vehicle's traveling direction indicated in the GPS data changes by 90 degrees, it can be determined that the vehicle is in a situation of making a right or left turn, and when the vehicle's traveling direction changes by 180 degrees, it can be determined that the vehicle is in a situation of moving rearward. These situations can also be determined from a change in scenery appearing in the image of the area surrounding the vehicle. When the map information includes information about road signs, traffic signals, stop points, or the like, it can be determined what type of road the vehicle is traveling on by using the map information.

### Technique 9

The visual target determination method according to any one of techniques 1 to 8, in which, the gaze area detection process includes adjusting a size of the gaze area based on an attribute of the driver, a state of the vehicle, or an environment surrounding the vehicle.

Accordingly, the size of the gaze area can be adjusted in accordance with the driver's attributes, the vehicle state, or the environment surrounding the vehicle. For example, since a driver who is an elderly or who has low driving skills may possibly have a narrow visual field, the size of the gaze area may be reduced to match the visual field according to the driver's attributes. Furthermore, for example, since the driver's effective visual field may possibly become narrower when the vehicle is traveling at a high speed, the size of the gaze area may be reduced to match the driver's effective visual field according to the vehicle state. Moreover, for example, since the driver's visual field may possibly become narrower when the vehicle is traveling in bad weather or during nighttime, the size of the gaze area may be reduced to match the driver's visual field according to the environment surrounding the vehicle.

### Technique 10

The visual target determination method according to any one of techniques 1 to 9, in which, the gaze area detection process includes assigning, to the gaze area, a weight having a value that increases with decreasing distance to a center of the gaze area, the visual target candidate detection process includes assigning, to a visual target candidate area, a weight having a value that increases with decreasing distance to a center of the visual target candidate area, the visual target candidate area being an area of the visual target candidate detected, and, in the visual recognition behavior determination process, whether the visual target candidate constituting the visual target candidate area is included in the gaze area is determined based on a sum of the value of the gaze area and the value of the visual target candidate area in an area where the gaze area and the visual target candidate area overlap.

Since an area located externally away from the center of the gaze area, which is the driver's gaze point, is an area that is difficult for the driver to visually recognize even when the area is within the gaze area, there is a possibility that an object within the relevant area is not properly visually recognized by the driver. Furthermore, when the driver views an area located externally away from the center of the visual target candidate area, there is a possibility that the visual target candidate is not properly visually recognized by the driver. By assigning weights to the gaze area and the visual target candidate area and calculating the sum of the values in the area where the gaze area and the visual target candidate area overlap, it can be comprehensively determined whether the driver has viewed the visual target candidate that should be visually recognized.

### Technique 11

The visual target determination method according to any one of techniques 1 to 10, in which, the visual target candidate detection process includes expanding a visual target candidate area when the visual target candidate detected is a predetermined object, the visual target candidate area being an area of the visual target candidate detected.

For example, although a traffic signal is a small object when viewed from the driver, the driver can visually recognize the traffic signal without gazing at the traffic signal so long as the traffic signal is within the visual field to some extent. This is because traffic-related man-made objects are made so that they are readily visually recognizable by drivers. When such a small object is detected at its original size, it is determined that such an object is not included in the gaze area, possibly determining that the driver has not visually recognized the object even though the driver actually has. With regard to such a preset object, the visual target candidate area is expanded, thereby suppressing a situation where it is determined that the driver has not visually recognized the object even though the driver actually has.

### Technique 12

The visual target determination method according to any one of techniques 1 to 11, in which, in the visual recognition behavior determination process, the visual target candidate is determined to be included in the gaze area when the visual target candidate corresponding to the traffic scene determined is included in the gaze area for a predetermined time period or longer.

Accordingly, this can suppress a situation where it is determined that the driver has been viewing the visual target candidate, which should be visually recognized by the driver, by only momentarily viewing the visual target candidate.

### Technique 13

A visual target determination system includes: a line of sight detector that detects a line of sight of a driver driving a vehicle; a gaze area detector that detects a gaze area based on the line of sight, detected, of the driver, the gaze area being an area gazed at by the driver; an image acquirer that acquires an image obtained by capturing an area surrounding the vehicle; a visual target candidate detector that detects a visual target candidate by recognizing an object included in the image, the visual target candidate being a candidate for a target toward which the line of sight of the driver is directed; a scene determiner that determines a traffic scene of the vehicle; and a visual recognition behavior determiner that determines whether a visual target candidate corresponding to the traffic scene determined is included in the gaze area, and determines that the driver has performed appropriate visual recognition behavior in the traffic scene determined when the visual target candidate corresponding to the traffic scene determined is included in the gaze area, and determines that the driver has not performed the appropriate visual recognition behavior in the traffic scene determined when the visual target candidate corresponding to the traffic scene determined is not included in the gaze area.

Accordingly, a visual target determination system that can determine whether a driver has viewed what should be viewed during driving can be provided.

### Further Information About Technical Background to this Application

The disclosure of the following patent application including specification, drawings, and claims is incorporated herein by reference in its entirety: Japanese Patent Application No. 2024-178451 filed on Oct. 10, 2024.

### Industrial Applicability

The present disclosure is applicable to a system or the like that determines whether a driver has viewed what should be viewed during driving.

1.
A visual target determination method comprising:
a line of sight detection process for detecting a line of sight of a driver driving a vehicle;
a gaze area detection process for detecting a gaze area based on the line of sight, detected, of the driver, the gaze area being an area gazed at by the driver;
an image acquisition process for acquiring an image obtained by capturing an area surrounding the vehicle;
a visual target candidate detection process for detecting a visual target candidate by recognizing an object included in the image, the visual target candidate being a candidate for a target toward which the line of sight of the driver is directed;
a scene determination process for determining a traffic scene that is a situation during driving of the vehicle; and
a visual recognition behavior determination process for determining whether a visual target candidate corresponding to the traffic scene determined is included in the gaze area, and determining that the driver has performed appropriate visual recognition behavior in the traffic scene determined when the visual target candidate corresponding to the traffic scene determined is included in the gaze area, and determining that the driver has not performed the appropriate visual recognition behavior in the traffic scene determined when the visual target candidate corresponding to the traffic scene determined is not included in the gaze area.

2.
The visual target determination method according to claim 1, wherein
in the visual recognition behavior determination process, whether a visual target candidate included in a visual target determination table corresponding to the traffic scene determined is included in the gaze area is determined, the visual target determination table being included in a plurality of visual target determination tables created for respective traffic scenes one of which is the traffic scene determined.

3.
The visual target determination method according to claim 2, wherein
in the visual recognition behavior determination process, whether a visual target candidate having a priority level higher than or equal to a predetermined priority level is included in the gaze area is determined, the visual target candidate being included in the visual target determination table corresponding to the traffic scene determined.

4.
The visual target determination method according to claim 3, wherein
the visual recognition behavior determination process includes changing the priority level of the visual target candidate in accordance with a distance between the vehicle and the visual target candidate included in the visual target determination table corresponding to the traffic scene determined.

5.
The visual target determination method according to claim 3, wherein
the visual recognition behavior determination process includes lowering a priority level of a visual target candidate included in a visual target determination table corresponding to a second traffic scene when a visual target candidate included in a visual target determination table corresponding to a first traffic scene that is determined is included in the gaze area, the first traffic scene and the second traffic scene being included in the respective traffic scenes, the second traffic scene following the first traffic scene.

6.
The visual target determination method according to claim 2, wherein
the plurality of visual target determination tables are created for the respective traffic scenes, based on a road traffic law, a traffic-related textbook, or a visual recognition behavior history of an arbitrary driver.

7.
The visual target determination method according to claim 1, wherein
in the visual target candidate detection process, a preset object disposed in the vehicle is detected as the visual target candidate.

8.
The visual target determination method according to claim 1, wherein
in the scene determination process, the traffic scene of the vehicle is determined based on global positioning system (GPS) data, the image, or map information.

9.
The visual target determination method according to claim 1, wherein
the gaze area detection process includes adjusting a size of the gaze area based on an attribute of the driver, a state of the vehicle, or an environment surrounding the vehicle.

10.
The visual target determination method according to claim 1, wherein
the gaze area detection process includes assigning, to the gaze area, a weight having a value that increases with decreasing distance to a center of the gaze area,
the visual target candidate detection process includes assigning, to a visual target candidate area, a weight having a value that increases with decreasing distance to a center of the visual target candidate area, the visual target candidate area being an area of the visual target candidate detected, and
in the visual recognition behavior determination process, whether the visual target candidate constituting the visual target candidate area is included in the gaze area is determined based on a sum of the value of the gaze area and the value of the visual target candidate area in an area where the gaze area and the visual target candidate area overlap.

11.
The visual target determination method according to claim 1, wherein
the visual target candidate detection process includes expanding a visual target candidate area when the visual target candidate detected is a predetermined object, the visual target candidate area being an area of the visual target candidate detected.

12.
The visual target determination method according to claim 1, wherein
in the visual recognition behavior determination process, the visual target candidate is determined to be included in the gaze area when the visual target candidate corresponding to the traffic scene determined is included in the gaze area for a predetermined time period or longer.

13.
A visual target determination system comprising:
a line of sight detector that detects a line of sight of a driver driving a vehicle;
a gaze area detector that detects a gaze area based on the line of sight, detected, of the driver, the gaze area being an area gazed at by the driver;
an image acquirer that acquires an image obtained by capturing an area surrounding the vehicle;
a visual target candidate detector that detects a visual target candidate by recognizing an object included in the image, the visual target candidate being a candidate for a target toward which the line of sight of the driver is directed;
a scene determiner that determines a traffic scene of the vehicle; and
a visual recognition behavior determiner that determines whether a visual target candidate corresponding to the traffic scene determined is included in the gaze area, and determines that the driver has performed appropriate visual recognition behavior in the traffic scene determined when the visual target candidate corresponding to the traffic scene determined is included in the gaze area, and determines that the driver has not performed the appropriate visual recognition behavior in the traffic scene determined when the visual target candidate corresponding to the traffic scene determined is not included in the gaze area.
